(19) United States
(12) Patent Application Publication
(10) Pub. No.: US 2021/0261742 A1
(43) Pub. Date: Aug. 26, 2021

(54) PROCESS FOR PRODUCING LIGNIN PARTICLES

(71) Applicant: TECHNISCHE UNIVERSITÄT WIEN, Vienna (AT)

(72) Inventors: Michael HARASEK, Vienna (AT); Anton FRIEDL, Vienna (AT); Stefan BEISL, Unterdietfurt (DE); Angela MILTNER, Maria Anzbach (AT); Martin MILTNER, Maria Anzbach (AT)

(21) Appl. No.: 17/255,847

(22) PCT Filed: Jun. 27, 2019
(86) PCT No.: PCT/AT2019/060209

§ 371 Date: Dec. 23, 2020

(30) Foreign Application Priority Data
Jun. 27, 2018 (AT) 50527/2018

(51) Int. Cl. C08J 3/14

(52) U.S. Cl. CPC C08J 3/14; C08J 2397/00

(57) ABSTRACT

Described is a process for producing lignin particles in the context of a continuous process, including a particle-free lignin-containing solution and a precipitation agent are combined in a mixing apparatus and subsequently passed out of the mixing apparatus again, wherein a mixing efficiency of the lignin-containing solution with the precipitation agent of at least 90% and a precipitation of lignin particles are achieved to form a suspension of lignin particles, and the residence time in the mixing apparatus does not exceed a duration of 30 seconds.

The present invention relates to a process for producing lignin particles by adding a precipitation agent to a particle-free lignin-containing solution.

Lignins are solid biopolymers consisting of phenolic macromolecules embedded in the plant cell wall. In plants, lignins are mainly responsible for the strength of the plant tissue. In the production of cellulose or paper from plant material, the solid cell wall constituent lignin is separated from the cellulose by various processes (e.g. sulphite process, kraft process, organosolv process).

Many petrochemicals are produced by conventional crude oil-processing refineries, although it is expected that in the future many products and chemicals will be produced by biorefineries fed with lignocellulosic biomass, such as agricultural residues. This makes the term “waste” obsolete in the context of biomass processing terminology, since any production stream has the potential to be converted into a by-product or energy instead of waste. However, lignin, the second most abundant biopolymer on earth after cellulose, is under-utilised in first-generation cellulose projects and most of this lignin is currently used as an energy source. However, economic analyses have shown that the use of biomass for energy applications alone is in many cases not economically viable and that the use of all biomass through a variety of processes is necessary to increase its economic value. Only about 40% of the lignin produced is needed to cover the internal energy needs of a biorefinery. Therefore, most of the lignin produced is available to increase the yield of a biorefinery beyond the utilisation of the carbohydrate fraction.

Lignin is a highly irregularly branched polyphenolic polyether consisting of the primary monolignols, p-coumaryl alcohol, coniferyl alcohol and sinapyl alcohol linked by aromatic and aliphatic ether bonds. Three different types of lignins can be roughly distinguished: softwood lignins are composed almost exclusively of coniferyl alcohol, hardwood lignins of coniferyl and sinapyl alcohol, and grass lignins of all three types. The high complexity and inhomogeneity of the lignin structure is in many cases even increased further by the currently applied pre-treatment technologies and leads to additional challenges for further processing and utilisation of the lignin. Compared to other pre-treatment technologies, the organosolv process used in the present case extracts the lignin from the biomass in a relatively pure, low-molecular form. This lignin shows a minimum of carbohydrate and mineral impurities and facilitates applications of the lignin of greater value than heat and energy production.

One approach to overcome this high complexity and inhomogeneity lies in the production and application of nanostructured lignin. Nanostructured materials, especially in the range of 1-100 nm, offer unique properties due to their increased specific surface area, and their essential chemical and physical interactions are determined by the surface properties. Consequently, a nanostructured material can have significantly different properties as compared to a larger-dimensioned material of the same composition. Therefore, the production of lignin nanoparticles and other nanostructures has sparked interest among researchers over recent years.

Lignin nano- and microparticles have various potential applications ranging from improved mechanical properties of polymer nanocomposites, bactericidal and antioxidant properties and impregnations, to excipients for hydrophobic and hydrophilic substances. Furthermore, carbonisation of lignin nanostructures can lead to high-value applications such as use in supercapacitors for energy storage. Furthermore, there are first attempts to upscale a precipitation process in tetrahydrofuran-water solvent systems. However, most of the production methods published to date have a very high solvent consumption in common. Huge amounts of solvents are needed for cleaning the lignin before precipitation, for the precipitation itself, and for the downstream processing.

US 2014/0275501 describes the production of lignin, which has a lower degree of degradation than conventionally isolated lignin. This involves extracting lignin from a biomass comprising lignin using a fluid comprising subcritical or supercritical water. In addition to water, the extraction agent may comprise, for example, methanol, ethanol or propanol, with such a mixture comprising at least 80 vol. % of the organic solvent. Lignin can finally be precipitated from a lignin-containing extraction solution by lowering the pH to about 2.

WO 2016/197233 concerns an organosolv process which can be used to produce high-purity lignin comprising at least 97% lignin. A lignin-containing starting material is first treated with a solvent mixture comprising ethanol and water to remove compounds from the starting material that dissolve in the solvent mixture. The lignin-containing material is then treated with a Lewis acid, which is also in a solvent mixture comprising, for example, ethanol and water. Finally, lignin is precipitated from the lignin-containing solution by lowering the pH.

NZ 538446 concerns processes for the treatment of lignin-containing materials, such as wood, for example in order to introduce active ingredients into them. However, a process for producing lignin particles is not disclosed.

WO 2010/058185 describes a biomass treatment process in which the biomass is separated into lignin and other components using ultrasound and an aqueous solvent system. According to this international patent application, one possible process step is to obtain lignin by evaporation from a water-immiscible solvent.

WO 2012/126099 also describes an organosolv process by means of which aromatic compounds, i.e. lignin, can be isolated from a biomass and precipitated by evaporation or lowering the pH value.

In WO 2013/182751, processes for the fractionation of lignin are disclosed, in which lignin is first dissolved with an organic solvent and water. The mixture is then ultra-filtered so that lignin fractions with a specific molecular weight can be produced. The lignin can then be precipitated.

The WO 2010/026244 relates, among other things, to various organosolv processes with which cellulose can be produced which is enriched with lignin, among other things.

Lignin and especially nanolignin is used in a wide range of industrial applications. The nanolignin obtained can be further processed in a variety of ways, e.g. by fixing chemical (e.g. medically or enzymatically active) ligands to the nanolignin or by making the nanolignin UV-protective by ultrasound treatment.

Nanolignin-based plastics are characterised by high mechanical stability and hydrophobic properties (dirt repellent). Therefore they are suitable for many applications, e.g. for use in the automotive industry. In particular, nanolignin can be used in different types of fillings, as reinforcing fibres, etc. The relevant literature shows, for example, that a controlled polymerisation of nanolignin particles with styrene or methyl methacrylate results in a tenfold increase of the material load capacity compared to a lignin/polymer mixture.

Nanolignin applied to textile surfaces provides active protection against UV radiation. This can lead to an application in the production of functional textiles.

The moisture-repellent and antibacterial properties of nanolignin open up applications in the packaging industry (production of special packaging films), especially in the field of food packaging.

Lignin nanoparticles can be interspersed with silver ions and coated with a cationic polyelectrolyte layer, thus providing a naturally degradable and “green” alternative to silver nanoparticles.

Due to its high biocompatibility and antibacterial effect, nanolignin is suitable for use in biofilms for implants, among other things. Nanolignin can also be used in the pharmaceutical industry, e.g. in the field of drug delivery.

Particles of lignin, especially nanoparticles of lignin, are currently mainly produced by dissolving already isolated and precipitated lignin (usually using lignosulphonates or lignosulphonate sources, e.g. black liquor or alkali lignin). In this case, the lignin precipitated for the first time has no particle or nanoparticle structure. These structures can be produced by dissolving already precipitated lignin and then precipitating it again or grinding it (see CN 103145999). Lignin particles or nanolignin can also be produced from black liquor, which is a lignin-rich by-product or waste product in paper or cellulose production, by means of CO₂-high pressure extraction (CN 102002165). CN 104497322 describes a process in which an ultrasonically treated lignin solution is added dropwise to deionised water and then nanolignin is separated by centrifuge.

In Beisl et al (Molecules 23 (2018), 633-646), a process for producing lignin micro- and nanoparticles is described, in which different parameters are described for the precipitation of lignin particles from lignin solutions.

In contrast to this prior art, the object of the present invention is to provide processes for producing lignin particles from lignin-containing solutions, with which well reproducible lignin nanoparticles, which are as homogeneous as possible with respect to their size distribution, can be produced, and in addition the processes should be cost and time efficient and easily transferable to industrial scale. Above all, the particles obtained should be nanoparticles and their average size should be below 400 nm, preferably below 300 nm, more preferably below 200 nm or even more preferably below 100 nm.

Accordingly, the present invention relates to a process for producing lignin particles in the context of a continuous process, in which a particle-free lignin-containing solution and a precipitation agent are combined in a mixer and subsequently discharged from the mixer again, with a mixing quality of the lignin-containing solution with the precipitation agent of at least 90% and a precipitation of lignin particles being achieved, resulting in a suspension of lignin particles, which process is characterised in that the residence time in the mixer does not exceed a period of seconds.

Furthermore, the present invention relates to a process for producing lignin particles in the context of a continuous process, in which a particle-free lignin-containing solution and a precipitation agent are combined in a mixing device and subsequently discharged from the mixing device again, with a mixing quality of the lignin-containing solution with the precipitation agent of at least 90% and a precipitation of lignin particles being achieved, resulting in a suspension of lignin particles, the mixing device comprising at least one mixer and the line leading out therefrom with a diameter of 10 mm or less, which process is characterised in that the residence time in the mixing device does not exceed a period of 30 seconds.

Surprisingly, by means of an extremely short mixing phase during the precipitation of the lignin particles, the process according to the invention was able to guarantee a quality of the lignin particles and a yield corresponding to those of much more complex processes. In particular, it has surprisingly been found that the process described by Beisl et al. (Molecules 23 (2018), 633-646) can even be significantly reduced—with regard to the precipitation step—without having to accept yield losses or quality losses in the resulting particle composition. In fact, with the process according to the invention, nanoparticles with average sizes of partly far below 400 nm, for example below 250 nm, in particular below 150 nm, can be reliably obtained, moreover with a remarkable homogeneity (see the examples section). Furthermore, the process according to the invention can be carried out according to preferred embodiments with water alone as precipitation agent, which enables an extremely simple, fast, environmentally friendly and cost-effective large-scale production of such lignin particles. In addition, if pure water is used as precipitation agent, a comparable yield of lignin particles can be achieved in comparison to a mixture of water and sulphuric acid with a pH value of 5 as precipitation agent, as shown in Beisl et al. (Molecules 23 (2018), 633-646).

The present invention is characterised in that, in a continuous process, the lignin precipitation step is carried out in a mixing step which is shortened compared to the prior art. The process can therefore be defined by keeping the residence time in a mixer or in the entire mixing device very short (i.e. less than 5 seconds in the mixer or less than 30 seconds in the entire mixing device).

In the context of the present invention, a “mixing device” is understood to be a unit in the continuous process sequence for producing lignin particles, in which the particle-free lignin-containing solution is contacted and mixed with the precipitation agent, and precipitation of the lignin particles is initiated. According to the invention, it consists at least of a mixer in which the particle-free lignin-containing solution is mixed with the precipitation agent in such a way that the two components are mixed as comprehensively as possible, moreover within a very short time. For this reason, the precipitation process according to the invention is generally also already substantially completed in the short residence time in the mixer, i.e. the particle size of the lignin particles is substantially already completely defined. In subsequent process steps, changes in size are generally only made possible or achieved by means of targeted or random process measures, for example by aggregation. However, the “precipitation process” is in any case already completed in the mixer when a mixing quality (thorough mixing) of the particle-free lignin-containing solution with the precipitation agent has been achieved to more than, e.g., 90 or 95%. In exceptional cases, however, a further mixing (and thus possibly precipitation processes) can also occur in the discharges from the mixer, e.g. through wall friction, if the mixing of the particle-free lignin-containing solution with the precipitation agent in the mixer was insufficient. Accordingly, the mixing process of the present invention, in which the precipitation of the lignin particles is achieved, can also be carried out in a mixing device, which, in addition to the actual mixer, also comprises (thin) lines in which, due to wall friction and a small diameter, any precipitation agent/lignin solution still incompletely mixed from the mixer can undergo further mixing and precipitation. In order that such further substantial mixing can take place at all, however, only lines with a diameter of 10 mm or smaller, in particular 5 mm or smaller, are considered.

A “particle-free lignin-containing solution” means any solution in which lignin is dissolved and which does not contain particles that interfere with the precipitation of lignin particles and their intended use. Depending on the process for producing the particle-free lignin-containing solution and the lignin-containing starting material with which it was obtained, physical or chemical cleaning steps may have to be provided for the production of “particle-free” lignin-containing solutions to remove such particles where necessary. The “particle-free lignin-containing solution” is therefore to be understood either as a solution saturated with lignin or a diluted form thereof—with regard to the lignin concentration. In the particle-free lignin-containing solution according to the present invention, the lignin concentration is thus below the solubility limit under the given conditions. Preferably, the particle-free lignin-containing solution is specified within the scope of the process according to the invention under conditions and using solvents that allow the highest possible lignin concentration.

With the “precipitation agent” a state is then brought about in which the solubility limit is exceeded in the particle-free lignin-containing solution. In principle, this can be achieved by adding liquid, gaseous as well as solid precipitation agents to the mixer; however, according to the invention, the addition of liquid precipitation agents is preferred. Liquid precipitation agents can be added relatively easily to the particle-free lignin-containing solution in a continuous process stream (for example by separate feeding into the mixer, by a T-piece directly before the mixer, or by introducing the precipitation agent into the solution stream also directly before the mixer). Although this also applies to the addition of solid precipitation agents or the introduction of gaseous precipitation agents, the specification according to the invention of the short contact time or the short mixing time in the mixer of seconds or less is somewhat more complex, especially if ordinary water is to be used as precipitation agent.

The “mixing quality” is defined by the variance of the concentrations in a control volume. The control volume in this case is an infinitesimally small length of the flow cross-section. The mixing quality is a measure for the homogeneity or uniformity of a mixture and is calculated from basic statistical values. The most common measure is the coefficient of variation. The closer this value is to 0, the more uniform the mixture is. To illustrate this, it is subtracted from 1 and expressed as a percentage. Therefore, 100% mixing quality (or coefficient of variation=0) means the best, but practically unattainable, mixing condition. The final relevant value is therefore (1-coefficient of variation)*100%. Mathematically, the coefficient of variation is the quotient of the standard deviation of the chemical composition of samples from the mixing chamber and the arithmetic mean value of the samples. For static mixers, the mixing chamber is the cross-section of the mixing tube with an infinitesimally small length. The value can therefore be interpreted as a relative error of the nominal composition over the mixer cross-section. With a mixing quality of 95% (coefficient of variation=0.05; often referred to as technical homogeneity)—as known from stochastics—about 68% of all samples would be within a range of +/−5% of the nominal composition. Already, 96% would be in the range +/−10%. This has general validity for all normally distributed random experiments. Technical homogeneity is therefore referred to here from 95% (definition of mixing quality in STRIKO process engineering; see also: Wikipedia “Mixing (process engineering)”).

A mixing quality of 90% is preferably achieved immediately after the mixing device. Even more preferred is a mixing quality of 90% immediately after the mixer.

A person skilled in the art is familiar with determining the mixing quality. In the context of the present invention, the “mixing quality” is the variance of the concentrations of solvent of the lignin-containing solution and precipitation agent.

In the context of the present invention, the mixing quality is preferably determined by spatially resolved measurement of the concentrations. The measurement of the mixing quality is preferably carried out during the operation of the mixing apparatus by means of non-invasive methods based on laser technology, and here preferably by means of Raman spectroscopy, preferably in combination with spatially resolved laser Doppler anemometry.

In spatially resolved Raman spectroscopy, in particular in combination with spatially resolved laser Doppler anemometry, the local composition and flow velocity are measured by means of laser technology on a pipe cross-section through which a fluid flows. The exact procedure for the measurement is described in AT 520.087 B1 or the publication Haddadi B., et al. Chemical Engineering Journal 334, 2018, 123-133.

As an alternative to spatially resolved Raman spectroscopy, Micro Particle Image Velocimetry can be used as a non-invasive method. Micro Particle Image Velocimetry (μPIV) and especially 3D-μPIV is a standard method for the determination of flow processes on the micro scale. However, it can also be used to determine the mixing quality when mixing two liquids if non-Brownian particles are added to one of the two liquids. The exact measurement procedure can be found in the following sources: Raffel, Markus, et al. Particle image velocimetry: a practical guide. Springer, 2018; Hoffmann, Marko, et al. Chemical engineering science 61.9 (2006):2968-2976.

Alternatively, the mixing quality can also be determined theoretically using CFD numerical flow simulation. In numerical flow simulation, problems related to fluid mechanics are preferably modelled by Navier-Stokes equations and solved numerically using the finite volume method. With this method, the quality of the mixing of two fluids can be predicted in a purely theoretical way in the entire considered flow space with high reliability. For this purpose, commercial software packages requiring a licence such as ANSYS Fluent, ANSYS CFX or Star-CCM from CD-adapco or packages from the OpenSource area such as OpenFOAM can be used. The correct procedure can be found in the available literature: Bothe, Dieter, et al. Chemie Ingenieur Technik 79.7 (2007):1001-1014; Ehrentraut, Michael. Numerical investigations on the mixing quality when stirring viscoplastic fluids: Flow simulation for the analysis of stirred, rheologically complex fluids. Springer Verlag, 2016.

Another alternative method for determining the mixing quality is the invasive isokinetic sampling from the flow and subsequent ex-situ analysis of the composition of the sample taken using high-performance liquid chromatography (HPLC). For ex-situ analysis by taking a sample from the flow and analysing it in an external analyser, isokinetic sampling is of crucial importance. The fluid flowing into the sample collector must have the same flow velocity as the surrounding fluid to prevent distortions of the composition of the sample taken. The procedure of isokinetic sampling is very well defined for particle-laden gas flows and also applies in this form in a similar way for liquid flows. The following standards must be observed: DIN EN ISO 29461-1:2014-03 Air filter inlet systems of rotary presses; Test methods; Part 1: Static filter elements (ISO 29461-1:2013); German version EN ISO 29461-1:2013. Beuth Verlag, Berlin; VDI 2066 Sheet 1:2006-11 Measuring particles; Dust measurements in flowing gases; Gravimetric determination of dust loading; Beuth Verlag, Berlin. Following isokinetic sampling, the mixing quality is determined by measuring the composition of the samples taken with a suitable measuring instrument, preferably by means of high-performance liquid chromatography (HPLC). A description of this method can be found in the following publication: Beisl, Stefan, et al. Molecules 23.3 (2018):633.

As mentioned above, the process according to the invention is mainly characterised by the provision of a short mixing or contact time between the particle-free lignin-containing solution and the precipitation agent. Within this short time, this should enable a substantially complete precipitation, whereby the lignin particles desired according to the invention are formed. According to the invention, the residence time in the mixer should therefore not exceed a period of 5 seconds.

According to preferred embodiments of the process according to the invention, however, considerably reduced residence times in the mixing device or in the mixer can be provided. For example, the residence time in the mixer is not more than 4 seconds, preferably not more than 3 seconds, even more preferably not more than 2 seconds, in particular not more than 1 second. Such short mixing times have nevertheless proven to be sufficient to obtain the desired lignin particles in the desired quality and in the desired size.

However, the residence time in the mixer is expediently at least 0.1 seconds, preferably at least 0.3 seconds, even more preferably at least 0.5 seconds, especially at least 0.6 seconds, most preferably at least 0.7 seconds. In a preferred embodiment, the residence time in the mixer is between 0.1 and 5 seconds, expediently between 0.3 and 4 seconds, even more preferably between 0.5 and 3 seconds, especially between 0.6 and 2 seconds, most preferably between 0.7 and 1 second.

If the mixture is to be obtained in the entire mixing device, the residence time in the mixing device in particularly preferred embodiments is not more than 25 seconds, preferably not more than seconds, in particular not more than 15 seconds. However, the residence time in the mixing device is expediently at least 0.5 seconds, preferably at least 1.5 seconds, even more preferably at least 3 seconds, especially at least 4 seconds, most preferably at least 5 seconds. In a preferred embodiment, the residence time in the mixing device is between 0.5 and 30 seconds, preferably between 1.5 and 25 seconds, even more preferably between 3 and 20 seconds, especially between 4 and 18 seconds, most preferably between 5 and seconds.

Preferably, the mixer according to the invention is selected from a static mixer, a dynamic mixer or combinations thereof. A static mixer contains no moving parts and is therefore also called a “passive mixer”. Dynamic mixers according to the present invention include mixers with moving mechanical parts as well as all active mixers. In active mixers, the energy required for the relative displacement of particles of the starting materials is not obtained from the starting materials themselves (e.g. ultrasonic waves, vibrations caused by rising bubbles or pulsating inflow). “Passive” mixers include all mixers in which the required energy is extracted from the inflowing raw materials.

Preferably, the particle-free lignin-containing solution comprises at least one organic solvent and water.

According to the invention, the particle-free lignin-containing solution can be made available in all possible ways. However, in principle, lignin-containing solutions from established industrial processes are preferably used as the starting material in the process according to the invention. Accordingly, the particle-free lignin-containing solution is preferably produced by a kraft lignin (KL) process, a soda lignin process, a lignosulfonate (LS) process, an organosolv lignin (OS) process, a steam explosion lignin process, a hydrothermal process, an ammonia explosion process, a supercritical CO₂ process, an acid process, an ionic-liquid process, a biological process or an enzymatic hydrolysis lignin (EHL) process. If necessary, the lignin preparations resulting from these processes can be converted by additional suitable steps into a particle-free lignin-containing solution which is fed into the process according to the invention. For example, EHL lignin is obtained only after pretreatment by one of the other processes described and subsequent enzymatic hydrolysis. The lignin then remains as a solid and must first be dissolved in a solvent to obtain a lignin-containing solution.

According to a preferred embodiment, the precipitation agent is water or a diluted acid, preferably sulphuric acid, phosphoric acid, nitric acid or an organic acid, especially formic acid, acetic acid, propionic acid or butyric acid, or CO₂, with water being a particularly preferred precipitation agent.

As already mentioned above, the precipitation agent is added in such a way that lignin particles are formed from the lignin-containing solution. The solubility limit must be exceeded by adding the precipitation agent. Preferably, the precipitation agent is a solution and the volume of the precipitation agent is at least 0.5 times, preferably at least twice, in particular at least five time, the volume of the lignin-containing solution, or the volume of the precipitation agent is 1 to 20 times, preferably 1.5 to 10 times, in particular 2 to 10 times the volume of the lignin-containing solution. Therefore, preferably a liquid precipitation agent is added in such a way that the concentration of the solvent in the lignin-containing solution is reduced in the range of 1 to 10,000 wt. %/s, preferably 10 to 5,000 wt. %/s, preferably 10 to 1,000 wt. %/s, preferably 10 to 100 wt. %/s, in particular 50 to 90 wt. %/s, in the mixing/precipitation process.

According to a preferred embodiment of the process according to the invention, the pH value of the precipitation agent is in the range of 2 to 12, preferably 3 to 11, in particular 4 to 8, or the pH value of the suspension of lignin particles is in the range of 2 to 12, preferably 3 to 11, in particular 4 to 8.

Preferably, a substantially complete mixing is achieved in the mixing device or mixer. Accordingly, a mixing quality of the lignin-containing solution with the precipitation agent of at least 95%, preferably of at least 98%, in particular of at least 99%, is achieved according to preferred embodiments.

According to a preferred embodiment, the particle-free lignin-containing solution contains an organic solvent, preferably an alcohol, a ketone or THF, with ethanol being particularly preferred, especially in a mixture with water. The water/ethanol system for the solution of lignin is well described and known in this field, especially with regard to the optimal solution conditions as well as the quantitative precipitation conditions. Surprisingly, however, it has been found, in accordance with the invention, that some of these parameters are not as critical in the process according to the invention as described in the prior art. For example, the dependence of the yield on the pH value is surprisingly not so critical in the context of the present invention; in fact, according to the invention, the yields at pH 5 and pH 7, for example, have proved to be quite comparable.

According to the invention, the particle-free lignin-containing solution preferably contains an organic solvent, preferably a C₁ to C₅ alcohol, in particular selected from the group consisting of methanol, ethanol, propanol, butanol, pentanol, ethane-1,2-diol, propane-1,2-diol, propane-1,2,3-triol, butane-1,2,3,4-tetraol and pentane-1,2,3,4,5-pentol; or a ketone selected from acetone and 2-butanone.

Preferably, the particle-free lignin-containing solution contains an organic solvent in an amount of 10 to 90 wt. %, preferably to 80 wt. %, even more preferably 30 to 70 wt. %, even more preferably 40 to 60 wt. %, even more preferably 50 to 65 wt. %. In this field, as mentioned above, the optimum solution conditions for the individual organic solvents are largely known. Therefore, it is not only known which organic solvents are suitable in principle as lignin-dissolving solvents (only these are naturally considered as “organic solvents” according to the invention), but also in what quantities they should be used in principle (for example also when mixed with water) and at what quantities or under what conditions the solubility of lignin is particularly high.

In principle, the process according to the invention can be carried out at all temperatures at which the particle-free lignin-containing solution is present in liquid form. However, according to the invention, process temperatures are preferably used which allow an efficient and possibly energy-saving operation of the process. Therefore, precipitation according to the invention is carried out at a temperature of 0 to 100° C., preferably from 5 to 80° C., even more preferably from 10 to 60° C., even more preferably from 15 to 50° C., even more preferably from 20 to 30° C. For the sake of simplicity, the precipitation process according to the invention can be carried out at room temperature or at ambient temperature.

As mentioned above, the particle-free lignin-containing solution is a saturated lignin solution or a diluted form thereof. Depending on the solvent and the origin of the lignin, the absolute concentration of lignin in a saturated solution is of course different. According to the invention, particle-free lignin-containing solutions which contain lignin in an amount of 0.1 to 50 g lignin/L, preferably from 0.5 to 40 g/L, even more preferably from 1 to 30 g/L, and even more preferably from 2 to 20 g/L are preferably used.

In the continuous process according to the invention, the suspension with the lignin particles obtained is passed from the mixer or mixing device and subjected to the further production process. This can be achieved by introducing it into collection containers, from which further cleaning steps such as washing or centrifuging of the lignin particles can follow. It is therefore preferable to place the lignin particles or the suspension of lignin particles in a suspension container after the mixer or after the mixing device. As already mentioned above, at this stage of the process no more fundamental changes are made to the lignin particles, in particular no further significant precipitation processes or processes that shift the particle size significantly downwards. If desired, specific aggregation processes can be initiated.

As also mentioned above, particle-free lignin-containing solutions of various origins can be used as a basis for the precipitation process according to the invention. In principle, lignin is obtained by extraction of lignin-containing raw materials. Preferably, the particle-free lignin-containing solution is obtained by extraction of lignin-containing starting material selected from material of multi-year plants, preferably wood, wood waste or shrub cuttings, or material of single-year plants, preferably straw, or biogenic waste. Here, the lignin-containing starting material can be subjected to the extraction process with an average size of 0.5 to 50 mm, preferably from 0.5 to 40 mm, even more preferably from 0.5 to 30 mm, even more preferably from 1 to 25 mm, even more preferably from 1 to 20 mm, even more preferably from 5 to 10 mm.

For the extraction of lignin from lignin-containing raw materials, there are a number of extraction processes, also industrially established, which are also used as preferred manufacturing processes according to invention. Accordingly, the extraction of lignin-containing raw material is preferably carried out at a temperature of 100 to 230° C., preferably from 120 to 230° C., even more preferably from 140 to 210° C., even more preferably from 150 to 200° C., even more preferably from 160 to 200° C., even more preferably from 170 to 200° C., even more preferably from 170 to 195° C., even more preferably from 175 to 190° C. The extraction of lignin-containing starting material can be carried out, for example, at a pressure of 1 to 100 bar, preferably 1.1 to 90 bar, even more preferably 1.2 to 80 bar, even more preferably 1.3, to 70 bar, even more preferably 1.4 to 60 bar.

If necessary, the particle-free lignin-containing solution is obtained by extraction of lignin-containing starting material and subsequent removal of solid particles still present in the extraction mixture.

As also described at the outset, the particles obtainable according to the invention are of high quality, especially with regard to their nanoparticle properties, size distribution and homogeneity. Despite the short precipitation time according to the invention, the particles obtained have a comparatively very small diameter.

The lignin particles obtainable according to the invention have, in the suspension, an average diameter of less than 400 nm, preferably of less than 250 nm, even more preferably of less than 200 nm, even more preferably of less than 150 nm, especially of less than 100 nm, according to preferred variants of the process according to the invention.

At least 50% or more of the lignin particles obtainable according to the invention have, in the suspension, a size, measured as hydrodynamic diameter (HD), in particular measured with dynamic light scattering (DLS), of less than 400 nm, preferably less than 300 nm, even more preferably less than 250 nm, in particular less than 150 nm, even more preferably less than 100 nm, according to likewise preferred variants of the process according to the invention.

At least 60% or more, preferably at least 70% or more, even more preferably at least 80% or more, in particular at least 90% or more of the lignin particles obtainable according to the invention have, in the suspension, a size, measured as hydrodynamic diameter (HD), in particular measured with dynamic light scattering (DLS), of less than 500 nm, preferably less than 300 nm, even more preferably less than 250 nm, even more preferably less than 200 nm, in particular less than 100 nm, according to likewise preferred variants of the process according to the invention.

The present invention is explained in more detail by means of the following examples and the figures in the drawing, but without being limited to them.

In the drawing:

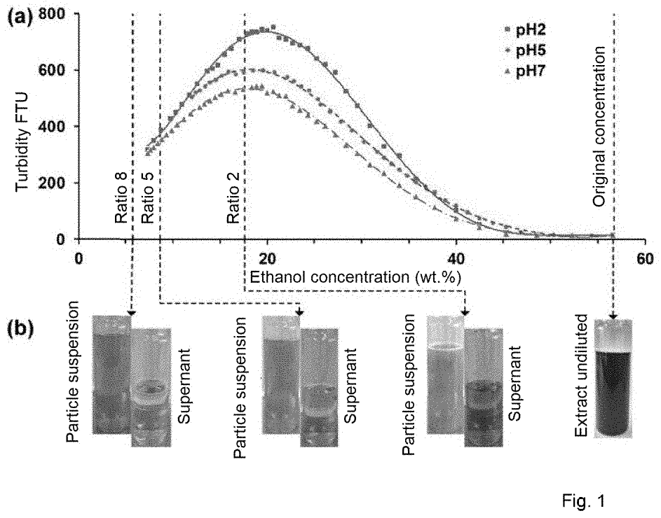

FIG. 1 shows: (a) turbidity against ethanol concentration in solution/suspension. The ethanol concentration was gradually reduced by adding precipitation agent at different pH values to the organosolv extract in a stirred tank; (b) The images of the particle suspensions and supernatants after centrifugation, obtained from precipitates in the static mixer with pH 5 precipitation agent and a flow rate of 112.5 ml/min.

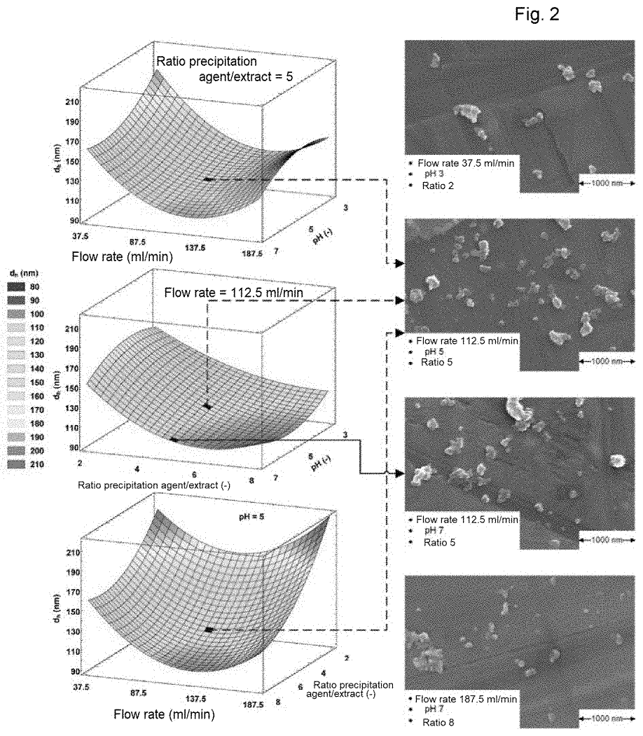

FIG. 2 shows: the effect of the interaction of the independent variables on the hydrodynamic diameter of the resulting particles and SEM images of selected precipitation parameters.

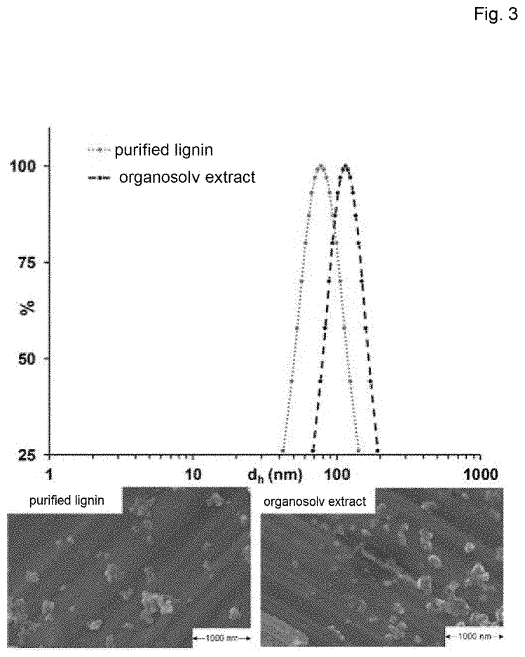

FIG. 3 shows: distributions of hydrodynamic diameter of and SEM images of lignin particles precipitated directly from organosolv extract or from a solution of purified lignin. The parameters used were pH 7, precipitation agent to extract ratio of 5, and a flow rate of 112.5 ml/min in the static mixer.

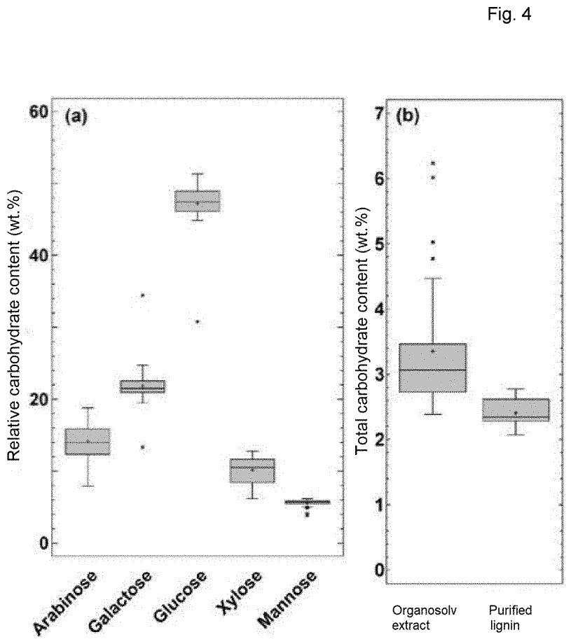

FIG. 4 shows: (a) Boxplot diagrams of the relative carbohydrate content found in the 34 individual experiments; (b) Boxplot diagram of the total carbohydrate content in the direct precipitation from organosolv extracts and in the purified lignin.

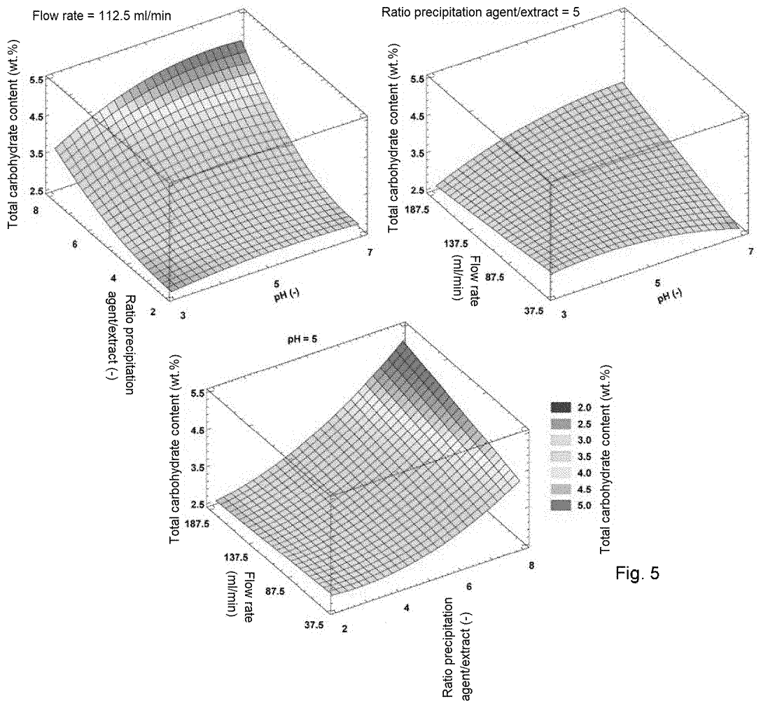

FIG. 5 shows: the effect of the interaction of the independent variables on the total carbohydrate content of the resulting dry precipitate.

### EXAMPLES: DIRECT PRECIPITATION OF LIGNIN NANOPARTICLES

Summary:

Micro- and nano-sized lignin shows improved properties compared to standard lignin available today and has gained interest in recent years. Lignin is the largest renewable resource on earth with an aromatic skeleton, but is used for relatively low-value applications. However, the use of lignin on the micro to nano scale could lead to valuable applications. Current production processes consume large quantities of solvents for purification and precipitation. The process investigated in this paper applies the direct precipitation of lignin nanoparticles from organosolv pre-treatment extract in a static mixer and can drastically reduce solvent consumption. pH value, precipitation agent to organosolv extract ratio, and flow rate in the mixer were investigated as precipitation parameters in relation to the resulting particle properties. Particles in size ranges from 97.3 nm to 219.3 nm could be produced, and with certain precipitation parameters the carbohydrate contamination reaches values as low as those for purified lignin particles. Yields were 48.2±4.99% regardless of the precipitation parameters. The presented results can be used to optimise the precipitation parameters with regard to particle size, carbohydrate impurities or solvent consumption.

Introduction

This paper focuses on the direct precipitation of lignin nanoparticles from organosolv pre-treatment extracts (OSE) in a wheat straw biorefinery, potentially reducing the solvent consumption of the whole process. Precipitation is performed in a static mixer, resulting in smaller particles compared to batch precipitation (Beisl et al., Molecules 23 (2018), 633-646). It combines the most commonly used precipitation methods of solvent shifting and pH shifting and reduces lignin solubility by lowering the solvent concentration and lowering the pH (Lewis et al., Industrial Crystallization; Cambridge University Press: Cambridge, 2015; pp. 234-260). The degree of lignin supersaturation, the hydrodynamic conditions prevailing during the process and the pH of the fluid surrounding the particles are important parameters that influence the final particle size and behaviour. These mentioned process conditions are investigated by varying the precipitation parameters of pH value, ratio of precipitation agent to OSE, and the flow rate in the static mixer. The resulting particles were investigated with respect to particle size, stability, carbohydrate contamination and yield of the process. The best precipitation parameters were identified and a comparison was made with the precipitation of the previously purified and redissolved lignin.

### Experimental Part

Materials

The wheat straw used was harvested in 2015 in the province of Lower Austria and stored under dry conditions until use. The particle size was crushed in a cutting mill equipped with a 5 mm sieve, before the pre-treatment. The composition of the dry straw was 16.1 wt. % lignin and 63.1 wt. % carbohydrates, consisting of arabinose, glucose, mannose, xylose and galactose. Ultrapure water (18 MΩ/cm) and ethanol (Merck, Darmstadt, Germany, 96 vol. %, undenatured) were used in the organosolv treatment, and sulphuric acid (Merck, 98%) was additionally used in the precipitation steps.

Organosolv Pre-Treatment

The organosolv pre-treatment was carried out as previously described in Beisl et al (Molecules 23 (2018), 633-646). In brief, wheat straw was treated at a maximum temperature of 180° C. for 1 h in 60 wt. % aqueous ethanol. Residual particles were separated by centrifugation. The composition of the extract can be found in Table 1.

Precipitation

The applied precipitation arrangement is generally described in Beisl et al. (Molecules 23 (2018), 633-646). However, in comparison to Beisl et al., the time spent in the mixing device (consisting of the T-connector, a 20.4 cm long tube with an inner diameter of 3.7 mm containing the static mixing elements, and the 1 m long rubber hose (diameter 4 mm)) was considerably shorter for the present invention. Whereas Beisl et al. spent more than 36 s in the static mixing device (volume: about 15 ml at a flow rate of about 24 ml/min) and more than 5 s in the static mixer itself (volume: about 2.2 ml at a flow rate of about 24 ml/min), shorter mixing times (30 s or less) are used in the process according to the present invention. The time in the mixing device in the present examples ranges from about 23 s to 3 s and the time in the mixer in the present examples ranges from about 5 s to 0.6 s.

The assembly consists of two syringe pumps, a static mixer and a stirred collection vessel. The stirrer speed in the collection vessel was set to 375 rpm. The acidified precipitation agent with a pH value of 3 and 5 was set using sulphuric acid, and the pH 7 precipitation agent was pure water. The particles were separated from the suspension after precipitation in a ThermoWX-80+ ultracentrifuge (Thermo Scientific, Waltham, Mass., USA) at 288,000 g for 60 min. The supernatant was decanted and the precipitated substance was freeze-dried. For the purified lignin, lignin was precipitated from the same extraction process and purified by repeated ultrasonic treatment, centrifugation and replacement of the supernatant. The purified lignin (“purified lignin”; PL) was freeze-dried and then dissolved in an ethanol/water mixture at equal ethanol concentrations compared to undiluted OSE. This artificial extract was used for the comparison with direct precipitation.

Design of the Experiments

The experimental design and statistical analysis of the results were carried out using Statgraphics Centurion XVII software (Statpoint Technologies, Inc., USA). A face-centered central composite design comprising three central points with a full repetition (34 individual experiments) was applied for the precipitation parameters of flow rate in the static mixer, pH value of the precipitation agent, and volume ratio of precipitation agent to OSE. The flow rates in the static mixer were set to 37.5 ml/min, 112.5 ml/min and 187.5 ml/min. The precipitation agent to extract volume ratios were set to 2, 5 and 8, while the pH of the precipitation agent was 3, 5 and 7. The significance level was set at α=0.05 in all statistical tests.

The results from the face-centered central composite design were used to describe the effects of the independent variables using a cubic model approach. High coefficients of determination were achieved for the carbohydrate content (R² 0.89/Adj. R² 0.87) and particle size (0.92/0.88). Non-significant factors were gradually removed from the model and were not included in the results.

Characterisation

The ethanol concentration-dependent turbidity of the particle suspension was determined with a Hach 2100Qis (Hach, CO, USA). To stay within the calibration range, the extract was diluted 1:6 by volume with ethanol/water to maintain the undiluted ethanol concentration of the extract. Water or sulphuric acid/water mixtures were gradually added to a stirring vessel filled with the diluted extract and measured after each addition.

The hydrodynamic diameter (HD) of the particles was measured with dynamic light scattering (DLS) (ZetaPALS, Brookhaven Instruments, Holtsville, N.Y., USA). The measurements were performed in the particle suspension directly after precipitation—both undiluted and in a 1:100 dilution with pure water. Undiluted measurements were corrected for their viscosity and the refractive index of the obtained supernatant after centrifugation. For long-term stability tests, the particles were stored at 8° C. but measured at 25° C.

The ζ-potential was investigated with a ZetaPALS (Brookhaven Instruments, Holtsville, N.Y., USA). Dried particles were dispersed in water at an appropriate concentration of 20 mg/L and stored for 24 h before the measurement. Each measurement consisted of five runs, each with 30 sub-runs, and was performed at 25° C.

Freeze-dried particles were dispersed in hexane, spread on a sample holder and examined under a scanning electron microscope (SEM) (Fei, Quanta 200 FEGSEM). The samples were sputter-coated with 4 nm Au/Pd (60 wt. %/40 wt. %) before analysis.

The carbohydrate content was determined using sample preparation in accordance with the laboratory analytical procedure (LAP) of the National Renewable Energy Laboratory (NREL): “Determination of Structural Carbohydrates and Lignin in Biomass” (Sluiter et al., Determination of Structural Carbohydrates and Lignin in Biomass; Denver, 2008), but the samples were not neutralised after hydrolysis. A Thermo Scientific ICS-5000 HPAEC-PAD system (Thermo Scientific, Waltham, Mass., USA) with deionised water as eluent was used to determine arabinose, glucose, mannose, xylose and galactose.

The yield was determined by the difference in dry matter content of the particle suspension directly after precipitation and the supernatant of the particle suspension after centrifugation.

Results and Discussion

Ratio of Precipitation Agent/Organosolv Extract

The solubility of lignin depends strongly on the concentration of ethanol in ethanol/water solvent mixtures and the type of lignin (Buranov et al. Bioresour. Technol. 101 (2010), 7446-7455). To determine the required final ethanol concentration in the precipitation process and thus the ratio of precipitation agent to OSE, the turbidity was measured as a function of the ethanol concentration (see FIG. 1). Pure water and water/sulphuric acid mixtures were gradually added to the OSE in a stirred flask at an initial ethanol concentration of 56.7 wt. %. To remain within the measuring range of the turbidimeter, the initial OSE was diluted by a factor of 1:6 by mass, maintaining the initial ethanol concentration. The undiluted lignin concentration of 7.35 g/kg was therefore reduced to 1.23 g/kg. This could lead to a slight shift of the turbidity maxima towards lower ethanol concentrations, as the solubility limit is reached at lower ethanol concentrations. The maxima of the turbidity curves were used to determine the minimum precipitation agent/OSE ratios required for the precipitation. The turbidity maxima were reached at 19.9 wt. %, 18.1 wt. % and 17.9 wt. % for the addition of precipitation agent with a pH of 2, 5 and 7 respectively. The lowest precipitation agent/OSE ratio for the precipitation experiments was therefore set at 2, resulting in a final ethanol concentration in the suspension of 17.6 wt. %. Further investigated ratios were set to 5 and 8, resulting in a final ethanol concentration of 8.7 wt. % and 5.7 wt. % respectively, in order to increase the lignin supersaturation. The shift in the maxima of turbidity towards higher ethanol concentrations for decreasing pH values indicates a decreasing solubility of the lignin with decreasing pH values. However, the lowest pH of the precipitation agent used for the precipitation experiments in the static mixer was fixed at 3 instead of 2 due to an isoelectric point at a pH of around 2.5 identified in the ζ-potential measurements.

Particle Size

The independent variables of pH value of the precipitation agent, flow rate in the static mixer and precipitation agent/OSE ratio were investigated in relation to the resulting particle HD. The resulting particle suspensions were measured by dynamic light scattering (DLS) directly after precipitation in two variants: undiluted and in a 1:100 dilution with water. After correcting the viscosity and refractive index for the undiluted samples, the HDs for both dilutions were compared with a paired t-test and showed significantly equal results for both conditions. The results shown in FIG. 2 are based on the HDs obtained by diluted measurements.

The resulting HDs range from 97.3 nm to 219.3 nm. The smallest HD is achieved in precipitates with a precipitation agent/OSE ratio of 6.29, pH 7 and a flow rate of 132.06 ml/min. The particles with the highest HD result from a precipitation agent/OSE ratio of 2, pH 4.93 and a flow rate of 187.5 ml/min.

The HD of the particles shows a strong dependence on the flow rate with minima of between 107.25 ml/min and 138.0 ml/min depending on pH and ratio. This behaviour could result from changing flow conditions that influence the equilibrium of primary nucleation and agglomeration by changing the supersaturation of lignin and the collision rate of the resulting particles. At low flow rates the supersaturation is comparatively low and larger particles are formed. With increasing flow rates, the supersaturation of lignin increases, resulting in smaller particles. However, further increased supersaturation leads to higher collision and agglomeration rates (Lewis et al., Industrial Crystallization; Cambridge University Press: Cambridge, 2015; pp. 234-260).

A similar behaviour can be observed for the precipitation agent/OSE ratio. HDs decrease with increasing ratios due to higher supersaturation and coherently increasing nucleation rates. For example, at a constant pH of 5 and a flow rate of 112.5 ml/min, the HD of the particles decreases from 172.9 nm to 117.3 nm and 101.7 nm for ratios of 2, 5 and 8, respectively. However, the mechanical energy supply does not increase due to the constant flow rate. Therefore the particle collision rates depend only on the particle concentrations. Consequently, higher precipitation agent/OSE ratios coherently lead to lower agglomeration (Lewis et al., Industrial Crystallization; Cambridge University Press: Cambridge, 2018; pp. 130-150).

The pH value shows the least influence of the variables examined on the HD. The HD increases from 104.0 nm to 131.2 nm by raising the pH of the precipitation agent from 3 to 7 at a constant precipitation agent/OSE ratio of 5 and a flow rate of 112.5 ml/min. The increased HD at low pH could be explained by the ζ-potential of the particles, which decreases to pH 3 and reaches the isoelectric point at pH values around 2.5.

The OSE contains not only lignin, but also components such as carbohydrates, acetic acid and various degradation products, which must be considered as impurities during the precipitation process. In order to investigate the influence of these impurities, lignin was purified from used OSE and dissolved in an aqueous ethanol solution with an ethanol concentration of 56.7 wt. %, equal to undiluted OSE. The solubility of PL reached its limit at a concentration of 6.65 g/kg, which is lower than the lignin concentration of 7.35 g/kg in the OSE. Therefore, the OSE was diluted to the same concentration of lignin at constant ethanol concentration. The precipitation parameters were set at pH 7, ratio 5, and a flow rate of 112.5 ml/min, which is the closest experimental point to the calculated parameters for the smallest particles. The HD distributions and REM images of the precipitation directly from OSE and the dissolved PL are shown in FIG. 3. The PL precipitation results in an HD of 77.62±2.74 nm, whereas the precipitation directly from OSE leads to a higher HD of 102.7±7.75 nm. A comparable result was achieved by Richter et al. (Langmuir 2016, 32 (25), 6468-6477) with organosolv lignin dissolved in acetone and a precipitation leading to particles of about 80 nm in diameter. The SEM images show only minor differences and in both cases separate particles. However, based on the DLS results, a negative influence of the impurities can be observed with regard to particle size.

Yields

The precipitation yields were found to be independent of the precipitation parameters and had an average value of 48.2±4.99%. The standard deviation is quite high, but the values are normally distributed. For comparison, Tian et al. (ACS Sustain. Chem. Eng. 2017, 5 (3), 2702-2710) were able to achieve values between 41.0% and 90.9% using a dialysis procedure using dimethyl sulfoxide as a solvent for poplar, coastal pine and corn straw lignin and water as a precipitation agent. Moreover, this paper represents the most comparable process found in the literature, as it considers a complete process chain from raw material to finished lignin particles, including impurities. Yearla et al (J. Exp. Nanosci. 2016, 11 (4), 289-302) showed a process that produced 33% to 63% yield by rapidly adding lignin/acetone/water mixtures to water.

Carbohydrate Impurities

In addition to lignin, the OSE also contains carbohydrates as a major source of impurities during precipitation. In terms of concentration, the total carbohydrate content in the extract is 10.2% of the lignin content. Therefore, the resulting precipitated substance was analysed for its carbohydrate content after centrifugation and freeze drying.

The relative proportion of carbohydrates is shown in FIG. 4a. Glucose, with a relative proportion of 47.2±3.36%, is the predominant carbohydrate compound in the precipitated substance. FIG. 4b compares the carbohydrate concentrations found in the precipitated substance of the direct OSE experiments with the PL precipitates. The total carbohydrate content in the PL is 2.41±0.25 wt. % and appears to be covalently bound to the lignin. The lowest carbohydrate content found within all direct OSE precipitates was 2.39 wt. %, which is within the concentration range of the PL. This shows that certain precipitation parameters allow precipitation of almost pure lignin relative to the carbohydrates dissolved in the OSE that remain on the particles. FIG. 5 shows the dependencies of the carbohydrate contents on pH value, flow rate and precipitation agent/OSE ratio. The results are in a comparable range to the results of Huijgen et al. (Ind. Crops Prod. 2014, 59, 85-95), which achieved carbohydrate contents in precipitated wheat straw organosolv lignins of 0.4 wt. % to 4.9 wt. % with treatment temperatures between 190° C. and 210° C. However, the higher temperatures compared to the 180° C. used in this paper favour carbohydrate cleavage and lead to lower concentrations.

Contrary to the conclusion that a higher dilution factor would reduce the carbohydrate content, the carbohydrate concentration increases with an increase in the precipitation agent to extract ratio. The carbohydrate concentrations for a ratio of 2 are between 2.35 wt. % and 2.80 wt. % for precipitations with pH 3 and a flow rate of 187.5 ml/min or pH 4.79 and a flow rate of 37.5 ml/min. For a ratio of 8, a minimum concentration of 3.47 wt. % and a maximum of 6.10 wt. % can be found, both at a flow rate of 187.5 ml/min and a precipitation agent pH of 3 and 7 respectively.

A contrary behaviour is observed with increasing flow rates, which leads to either a decreasing or increasing carbohydrate content in the precipitated substance, depending on the pH and the ratio of precipitation agent/OSE. For a combination of pH 3, precipitation agent and a ratio of 2, the carbohydrate concentration decreases from 2.72 wt. % to 2.35 wt. % by increasing the flow rate from 37.5 to 187.5 ml/min. On the other hand, by increasing the flow rate by 150.0 ml/min at a pH of 5 and a precipitation agent/OSE ratio of 8, the carbohydrate content increases from 4.18 wt. % to 5.21 wt. %.

The pH value shows an increasing influence on increasing precipitation agent/OSE ratios and flow rates. The carbohydrate concentration at otherwise constant precipitation parameters can be reduced by up to 43% by changing the pH value of the precipitation agent. This maximum reduction is achieved at a precipitation agent/OSE ratio of 8 and a flow rate of 187.5 ml/min, and the carbohydrate content can be reduced from 6.09 wt. % to 3.47 wt. % by changing the pH from 7 to 3.

### CONCLUSION

The influence of the precipitation parameters of pH-value, ratio of precipitation agent to organosolv extract, and flow rate in the mixer was investigated with regard to the resulting particle properties. The direct precipitation of lignin nanoparticles from wheat straw organosolv extracts can drastically reduce the solvent consumption in a production process for lignin nanoparticles. Particles with size ranges from 97.3 nm to 219.3 nm could be produced, and the carbohydrate impurities reached as low values at certain precipitation parameters as in purified lignin particles. The results found in this paper can be used to optimise the precipitation parameters in terms of particle size, carbohydrate impurities or solvent consumption in an uncomplicated process design.

TABLE 1
Composition of the organosolv extract used in the
precipitation experiments

| Compound/property | Value | Unit |
|---|---|---|
| Ethanol | 511 | g/l |
| Total carbohydrates¹ | 0.677 | g/l |
| Monomer carbohydrates¹ | 0.201 | g/l |
| Acetic acid | 1.43 | g/l |
| Acid-insoluble lignin | 5.53 | g/l |
| Acid-soluble lignin | 1.09 | g/l |
| Density² | 0.901 | g/ml |
| Dry mass³ | 1.57 | wt. % |

¹Sum of the arabinose, galactose, glucose, xylose and mannose concentrations;
²at 25° C.;
³determined at 105° C.

1. A process for producing lignin particles in the context of a continuous process, comprising: a particle-free lignin-containing solution and a precipitation agent are combined in a mixer and then discharged from the mixer again; a mixing quality of the lignin-containing solution with the precipitation agent of at least 90% and a precipitation of lignin particles being achieved, resulting in a suspension of lignin particles; and
the residence time in the mixer does not exceed a period of 5 seconds.

2. A process for producing lignin particles in the context of a continuous process, comprising: a particle-free lignin-containing solution and a precipitation agent are combined in a mixing device and are subsequently discharged from the mixing device again, a mixing quality of the lignin-containing solution with the precipitation agent of at least 90% and a precipitation of lignin particles being achieved, resulting a suspension of lignin particles; the mixing device comprising at least one mixer and the line leading out thereof with a diameter of 10 mm or less, and
the residence time in the mixing device does not exceed a period of 30 seconds.

3. The process according to claim 1, characterised in that the residence time in the mixer does not exceed a period of 4 seconds, preferably 3 seconds, even more preferably 2 seconds, in particular 1 second.

4. The process according to claim 2, characterised in that the residence time in the mixing device does not exceed a period of 25 seconds, preferably 20 seconds, in particular 15 seconds.

5. The process according to claim 1, characterised in that the mixer is selected from a static mixer, a dynamic mixer or combinations thereof.

6. The process according to one claim 1, characterised in that the particle-free lignin-containing solution comprises at least one organic solvent and water or at least one organic solvent.

7. The process according to claim 1, characterised in that the particle-free lignin-containing solution is obtained by a kraft lignin (KL) process, a soda-lignin process, a lignosulfonate (LS) process, an organosolv-lignin (OS) process, a steam explosion lignin process, a hydrothermal process, an ammonia explosion process, a supercritical CO₂ process, an acid process, an ionic-liquid process, a biological process or an enzymatic hydrolysis lignin (EHL) process.

8. The process according to claim 1, characterised in that the precipitation agent is water or a diluted acid, preferably sulphuric acid, phosphoric acid, nitric acid or an organic acid, in particular formic acid, acetic acid, propionic acid or butyric acid, or CO₂, or a diluted lye, preferably caustic soda or potassium hydroxide, with water being particularly preferred as precipitation agent.

9. The process according to claim 1, characterised in that the precipitation agent is a solution and the volume of the precipitation agent is at least 0.5 times, preferably at least twice, in particular at least 5 times the volume of the lignin-containing solution.

10. The process according to claim 1, characterised in that the precipitation agent is a solution and the volume of the precipitation agent is 1 to 20 times, preferably 1.5 to 10 times, in particular 2 to 10 times the volume of the lignin-containing solution.

11. The process according to claim 1, characterised in that the pH of the precipitation agent is in the range of 2 to 12, preferably 3 to 11, in particular 4 to 8.

12. The process according to claim 1, characterised in that the pH of the suspension of lignin particles is in the range of 2 to 12, preferably 3 to 11, in particular 4 to 8.

13. The process according to claim 1, characterised in that a mixing quality of the lignin-containing solution with the precipitation agent of at least 95% is achieved in the mixing device.

14. The process according to claim 1, characterised in that the particle-free lignin-containing solution contains an organic solvent, preferably an alcohol, a ketone or THE, with ethanol being particularly preferred, in particular in a mixture with water.

15. The process according to claim 1, characterised in that the particle-free lignin-containing solution contains an organic solvent, preferably a C₁ to C₅ alcohol, in particular selected from the group consisting of methanol, ethanol, propanol, butanol, pentanol, ethane-1,2-diol, propane-1,2-diol, propane-1,2,3-triol, butane-1,2,3,4-tetraol and pentane-1,2,3,4,5-pentol; or a ketone selected from acetone and 2-butanone.

16. The process according to claim 1, characterised in that the precipitation is carried out at a temperature of 0 to 100° C., preferably of 5 to 80° C., even more preferably of 10 to 60° C., even more preferably of 15 to 50° C., even more preferably of 20 to 30° C.

17. The process according to claim 1, characterised in that the particle-free lignin-containing solution contains lignin in an amount of 0.1 to 50 g lignin/L, preferably 0.5 to 40 g/L, even more preferably 1 to 30 g/L, even more preferably 2 to 20 g/L.

18. The process according to claim 1, characterised in that the suspension of lignin particles from the mixer or mixing device is introduced into a suspension container.

19. The process according to claim 1, characterised in that the particle-free lignin-containing solution comprises an organic solvent in an amount of 10 to 90 wt. %, preferably 20 to 80 wt. %, even more preferably 30 to 70 wt. %, even more preferably 40 to 60 wt. %, even more preferably 50 to 65 wt. %.

20. The process according to claim 1, characterised in that the particle-free lignin-containing solution is obtained by extraction of lignin-containing starting material at a temperature of 100 to 230° C., preferably of 120 to 230° C., even more preferably of 140 to 210° C., even more preferably of 150 to 200° C., even more preferably of 160 to 200° C., even more preferably of 170 to 200° C., even more preferably of 170 to 195° C., even more preferably of 175 to 190° C.

21. The process according to claim 1, characterised in that the particle-free lignin-containing solution is obtained by extraction of lignin-containing starting material at a pressure of 1 to 100 bar, preferably 1.1 to 90 bar, even more preferably 1.2 to 80 bar, even more preferably 1.3 to 70 bar, even more preferably 1.4 to 60 bar.

22. The process according to claim 1, characterised in that the particle-free lignin-containing solution is obtained by extraction of lignin-containing starting material selected from material of multi-year plants, preferably wood, wood waste or shrub cuttings, or material of single-year plants, preferably straw, or biogenic waste.

23. The process according to claim 1, characterised in that the particle-free lignin-containing solution is obtained by extraction of lignin-containing starting material having an average size of 0.5 to 50 mm, preferably of 0.5 to 40 mm, even more preferably of 0.5 to 30 mm, even more preferably of 1 to 25 mm, even more preferably of 1 to 20 mm, even more preferably of 5 to 10 mm.

24. The process according to claim 1, characterised in that the particle-free lignin-containing solution is obtained by extraction of lignin-containing starting material and subsequent removal of solid particles still present in the extraction mixture.

25. The process according to claim 1, characterised in that the lignin particles in the suspension have an average diameter of less than 400 nm, preferably less than 250 nm, even more preferably less than 200 nm, even more preferably less than 150 nm, in particular less than 100 nm.

26. The process according to claim 1, characterised in that at least 50 or more of the lignin particles in the suspension have a size, measured as hydrodynamic diameter (11D), in particular measured with dynamic light scattering (DIS), of less than 400 nm, preferably of less than 300 nm, even more preferably of less than 250 nm, in particular of less than 150 nm, even more preferably of less than 100 nm.

27. The process according to claim 1, characterised in that at least 60% or more, preferably at least 70% or more, even more preferably at least 80% or more, in particular at least 90% or more; of the lignin particles in the suspension have a size, measured as hydrodynamic diameter (HD), in particular measured with dynamic light scattering (DLS), of less than 500 nm, preferably less than 300 nm, even more preferably less than 250 nm, even more preferably less than 200 nm, in particular less than 100 nm.

28. The process according to claim 1, characterised in that the precipitation agent is a liquid precipitation agent and is added in such a way that the concentration of a solvent in the lignin-containing solution is reduced in the range of 1 to 10,000 wt. %/s, preferably 10 to 5,000 wt. %/s, preferably 10 to 1,000 wt. %/s, preferably 10 to 100 wt. %/s, in particular 50 to 90 wt. %/s, in the mixer or in the mixing device.
